(19) United States
(12) Patent Application Publication
(10) Pub. No.: US 2025/0050756 A1
(43) Pub. Date: Feb. 13, 2025

(54) CHARGING CONNECTION DEVICE FOR AN ELECTRICALLY POWERED VEHICLE

(71) Applicant: MERCEDES-BENZ GROUP AG, Stuttgart (DE)

(72) Inventors: Mark RENNER, Esslingen (DE); Karina KOHLER, Boeblingen (DE); Juergen BENECKE, Ludwigsburg (DE); Holger STEIN, Arnsberg (DE)

(21) Appl. No.: 18/717,484

(22) PCT Filed: Dec. 2, 2022
(86) PCT No.: PCT/EP2022/084318

§ 371 Date: Jun. 7, 2024

(30) Foreign Application Priority Data
Dec. 9, 2021 (DE) 10 2021 006 078.4

(51) Int. Cl. B60L 53/16; B60L 53/10; E05B 81/70; E05B 83/28; E05F 15/60

(52) U.S. Cl. CPC B60L 53/16; E05B 81/70; E05B 83/28; E05F 15/60; B60L 53/11; E05Y 2900/534

(57) ABSTRACT

A charging connection device for an electrically powered vehicle with two adjacently arranged charging connections having one of the charging connections being a combined DC-AC charging connection with two types of contact elements and a further charging connection is a DC charging connection or an AC charging connection or as a further DC-AC charging connection. The two adjacently arranged charging connections are electrically coupled via a common electrical path. The charging connection device includes at least two movably mounted charging connection covers, each assigned to one of charging connections. The charging connection covers each cover the corresponding charging connection in at least one covering position and at least partially release contact elements of the corresponding charging connection in at least one releasing position.

### BACKGROUND AND SUMMARY OF THE INVENTION

Exemplary embodiments of the invention relate to a charging connection device for an electrically powered vehicle with two charging connections.

DE102021000307A1 discloses a charging connection device for an electrically powered vehicle with two adjacently arranged charging connections with a first DC charging connection and a second DC and/or AC charging connection. In addition, the charging connection device comprises at least one charging connection cover that covers at least one of the two charging connections. The charging connection cover is designed in such a way that only one of the two charging connections is accessible for contacting, while the other of the two charging connections is covered by the charging connection cover.

According to the prior art, electric cars required a separate charging connection for each charging standard and therefore two charging connections are provided on the vehicle for two charging options of different standards.

A charging standard can include DC charging, which is understood to mean charging with direct current, or AC charging, which is understood to mean charging with alternating current.

One charging standard currently used in Europe, for example, is the Combined Charging System (CCS). This allows charging with direct current and alternating current. Another standard, CHAdeMO=“Charge de Move”, was developed in Japan and offers a charging capacity of up to 50 kW.

For alternative or future charging standards with outputs of several hundred kilowatts or even more with outputs of at least one megawatt and more, a further charging connection, in particular a DC voltage connection, is provided in accordance with a further, alternative plug standard. Several charging connections can be electrically connected in one path so that the charging sockets are energized at the same time.

Exemplary embodiments of the invention are directed to an improved charging connection device for an electrically powered vehicle with two charging connections.

Expedient embodiments and advantages of the invention can be found in t the description and drawings.

According to one aspect of the invention, a charging connection device for an electrically powered vehicle is disclosed with two adjacently arranged charging connections, which are electrically coupled via a common electrical path. At least one of the two charging connections is designed as a combined DC-AC charging connection with two types of contact elements. A further charging connection is designed as a DC charging connection or as an AC charging connection or as a further DC-AC charging connection. The two adjacently arranged charging connections are electrically coupled via a common electrical path. The charging connection device also comprises at least two movably mounted charging connection covers, wherein each charging connection is assigned at least one of the charging connection covers. The charging connection covers each cover the corresponding charging connection in at least one covering position and at least partially release contact elements of the corresponding charging connection in at least one releasing position. An inhibiting arrangement inhibits at least one of the charging connection covers for a transition from the at least one covering position to at least one releasing position or inhibits the at least one charging connection cover for a transition between the releasing positions if the release of the charging connection assigned to the charging connection cover or its contact elements is not required for the current charging mode. Alternatively, or additionally, the inhibiting arrangement inhibits the at least one charging connection cover if at least one of the other charging connection covers has one of the releasing positions. As a result, during a charging process, only one charging connection assigned to the charging mode or contact elements of the charging connection assigned to the charging mode are accessible for contacting, while the other of the two charging connections or the other contact elements are covered by the respective charging connection cover, in particular covered so that they cannot be touched.

In the following, a charging connection is understood to be a device, for example a charging socket, which is electrically coupled to an energy storage device and which can be electrically connected to a corresponding plug which is electrically coupled to a voltage source. When connected, the energy storage device of the electrically powered vehicle is charged by the voltage source. The charging connection has contact elements arranged in the form of a mating face, wherein the plug has a mating face with contact elements arranged congruently with contact elements of the charging connection.

One of the charging connections is designed as a combined DC-AC charging connection, in particular as a CCS charging connection, and has two types of contact elements. The AC contact elements form a first mating face, which can be coupled with a mating face of a plug with congruent contact elements in order to charge the vehicle or its energy storage system with alternating current. The DC contact elements form a second mating face. A plug, which is coupled to the combined DC-AC charging connection in order to charge the vehicle or its energy storage device with alternating current, has two mating faces, which can be coupled to the two mating faces of the combined DC-AC charging connection.

The other charging connection can be a DC charging connection or an AC charging connection or another combined DC-AC charging connection.

By sharing the electrical path of the two charging connections, it is sufficient to use only one contactor in the electrical architecture of the vehicle's high-voltage electrical system to connect the electrical energy storage system. This saves costs, installation space, and weight compared to a connection with two contactors. If the two charging connections are arranged in a shared electrical path, both charging connections are energized at the same time.

The charging connection covers mechanically cover the respective charging connections or the contact elements not required for the current charging mode.

Due to the charging connection covers and the inhibiting arrangement, the charging connection device can fundamentally have four or more states, wherein in a first state, both charging connections are covered by the respective charging connection cover or by the respective charging connection covers. In a second state of the charging connection device, the DC contact elements of the combined DC-AC charging connection and the other charging connection can be covered by the respective charging connection cover. As a result, in the second state, only the AC contact elements of the combined DC-AC charging connection are released for a CCS AC charging mode. In a third state of the charging connection device, the other charging connection can be covered by the respective charging connection cover and the AC contact elements and the DC contact elements of the combined DC-AC charging connection can be released for a CCS DC charging mode. In a fourth state, the combined DC-AC charging connection can be covered by the respective at least one charging connection cover and the other charging connection can be at least partially released for a corresponding charging mode by the respective at least one charging connection cover. If the other charging connection also has different contact elements for different charging modes, further states of the charging connection cover are conceivable.

Due to these states of the charging connection device, it is only possible to couple a charging plug of a charging cable with the corresponding contact elements of the charging connection if the other charging connection or the contact elements that are not required are covered with the respective charging connection cover so that they are safe to touch. This is an advantageous way of ensuring that the unused, energized contact elements are covered so that they are safe to touch while the energy storage device is charging. In addition, the unused, energized contact elements can be protected from environmental influences such as dirt or water in an advantageous manner. Furthermore, the charging connection covers reliably cover the respective charging connection while the vehicle is being driven or parked when it is not being charged and protect the connections from environmental influences and possible contact.

The charging connection covers and the inhibiting arrangement make it possible to dispense with a de-energization of one of the charging connections in an advantageous way. This means that there is no need for a corresponding switching device, a so-called switch box, which saves additional costs and additional installation space.

According to an advantageous embodiment of the charging connection device, at least one sensor arrangement coupled to the inhibiting arrangement can monitor the current position of the charging connection covers. Alternatively, or additionally, at least one sensor arrangement coupled to the inhibiting arrangement can recognize the current charging mode. By determining the current charging mode, the required contact elements assigned to the current charging mode can be determined for the current charging mode and the corresponding charging connection covers can be moved fully automatically or semi-automatically into the corresponding position. Furthermore, it is conceivable that the charging connection covers assigned to the contact elements that are not required can be locked in the position covering the contact elements that are not required in order to make it more difficult for these contact elements to be released or to prevent them from being released. By monitoring the positions of the charging connection covers, it is possible to determine whether contact elements are already released by a corresponding charging connection cover. As a result, the charging connection covers covering the other contact elements can be inhibited in the corresponding position for a transition to the position releasing these contact elements. The at least one sensor arrangement can comprise a limit switch and/or an optical sensor and/or a camera and/or a position measuring system or potentiometer. In addition, the sensor arrangement can be connected to a charging station via a communication system in order to obtain information about the selected charging mode.

According to an advantageous design of the charging connection device, at least one drive can, depending on the charging mode recognized by the sensor arrangement, move the charging connection covers into the position in which only the charging connection assigned to the charging mode or the contact elements of the charging connection assigned to the charging mode are released. This enables fully automatic or semi-automatic release of the required contact elements.

According to an advantageous design of the charging connection device, at least three movably mounted charging connection covers can be provided, wherein a first charging connection cover is assigned to AC contact elements of the combined DC-AC charging connection, a second charging connection cover is assigned to DC contact elements of the combined DC-AC charging connection, and at least a third charging connection cover is assigned to the other charging connection. If a CCS AC charging mode is recognized, the first charging connection cover is transferred to the releasing position or released for a transfer to the releasing position. The second charging connection cover and the at least one third charging connection cover remain in the covering position; in addition, the second charging connection cover and the at least one third charging connection cover can be locked in the covering position. If a CCS DC charging mode is recognized, the first charging connection cover and the second charging connection cover are transferred to the releasing position or released for transfer to the releasing position. The at least one third charging connection cover remains in the covering position, and the at least one third charging connection cover can also be locked in the covering position. If a charging mode is recognized, which is executed with the further charging connection, the at least one third charging connection cover is transferred to the releasing position or released for the transfer. The first charging connection cover and the second charging connection cover remain in the covering position, and the first charging connection cover and the second charging connection cover can also be locked in the covering position.

According to an advantageous embodiment of the charging connection device, two movably mounted charging connection covers can be provided, wherein a first charging connection cover is assigned to the combined DC-AC charging connection and a second charging connection cover is assigned to the other charging connection, wherein at least the first charging connection cover can be moved between the covering position and two releasing positions. In the covering position, the first charging connection cover can cover the AC contact elements and the DC contact elements. In the first releasing position, the first charging connection cover can release the AC contact elements and cover the DC contact elements. The first charging connection cover can release the AC contact elements and the DC contact elements in the second releasing position. If a CCS AC charging mode is recognized, the first charging connection cover is transferred to the releasing position or released for a transfer to the releasing position. In addition, the first charging connection cover can be locked in the first releasing position. The second charging connection cover remains in the covering position, and the second charging connection cover can also be locked in the covering position. If a CCS DC charging mode is recognized, the first charging connection cover is transferred to the second releasing position or released for a transfer to the releasing position. In addition, the first charging connection cover can be locked in the second releasing position. The second charging connection cover remains in the covering position, and the second charging connection cover can also be locked in the covering position. If a charging mode is recognized, which is carried out with the other charging connection, the second charging connection cover is transferred to the releasing position or released for the transfer. The first charging connection cover remains in the covering position, and the first charging connection cover can also be locked in the covering position.

According to an advantageous embodiment of the charging connection device, the two charging connections can be arranged in a common charging recess or in two separate, in particular adjacent, charging recesses. When arranged in a common charging recess, the charging connections can be arranged on the vehicle to save space. If they are arranged in separate charging recesses, the positioning of the charging connections can be more flexible.

According to an advantageous embodiment of the charging connection device, at least one charging recess can comprise at least one cover element, which covers the corresponding charging recess in at least a first position and at least partially releases the corresponding charging recess in at least a second position. In this case, the cover element can be arranged above the charging connection covers arranged in the corresponding charging recess in relation to a vehicle environment. The additional cover element can additionally cover the charging connection arranged in the charging recess and the at least one charging connection cover assigned to it or the charging connections arranged in the charging recess and the charging connection covers assigned to them and protect them from dirt, moisture and/or snow. In particular, if the charging connections are arranged in a common charging recess, both charging connections and their charging connection covers can be covered or at least partially released by the same cover element. The cover element can be arranged on one side of the corresponding charging recess. The cover element can be moved fully automatically or semi-automatically between a position covering the corresponding charging recess and a position at least partially releasing the corresponding charging recess, or can be released for such a movement.

According to an advantageous embodiment of the charging connection device, the inhibiting arrangement can comprise at least one locking element, which locks a corresponding charging connection cover in at least one covering position or in at least one releasing position. Additionally, or alternatively, the inhibiting arrangement can comprise at least one blocking arrangement that blocks at least one drive that drives the charging connection covers. The at least one locking element and/or the at least one blocking arrangement can advantageously prevent or at least make it more difficult for the charging connection cover, which has the covering position, to be transferred to the releasing position when the other charging connection cover has one of the releasing positions. In addition, it can be prevented or made more difficult for the charging connection cover, which has the first releasing position, to be moved to the second releasing position. In this case, the locking element can be designed as a locking pin, for example, which mechanically locks the corresponding charging connection cover. This locking pin can be moved between a locking position and an unlocking position by means of a suitable arrangement. The locking element can prevent or hinder manual movement of the corresponding charging connection cover locked by the locking element, and mechanical movement of the corresponding charging connection cover locked by the locking element can also be prevented or hindered using a suitable drive. In the blocking state, the blocking arrangement can mechanically block the at least one drive that drives the charging connection cover. Alternatively, or additionally, in the blocking state, the blocking arrangement can act on a mechanical force transmission path between the drive and the corresponding charging connection cover in order to block it or decouple it from the charging connection cover. It would also be conceivable to interrupt a power supply for a drive designed as an electric motor or actuator using the blocking arrangement in the blocking state. The blocking arrangement can prevent or make it more difficult for the charging connection cover to be transferred to the releasing or second releasing position via the drive in the covering position or in the first releasing position. The force resistance can also make it difficult or impossible to move the corresponding charging connection cover manually. This can be controlled via sensors and actuators, but can also be realized passively using simple mechanical functions.

According to an advantageous embodiment of the charging connection device, at least one of the charging connection covers and/or the at least one cover element can be designed as a rotationally movably and/or translationally movably mounted flap. In this case, the flap can be swiveled upwards or downwards or to the side or diagonally outwards away from the respective charging connection or from the charging recess on a suitable axis in order to be transferred to one of the releasing positions. For example, the flap can be arranged in a similar way to a conventional fuel filler flap on the side of the charging recess or on the side of the charging connection, which can correspond to the fuel filler recess arranged on an internal combustion vehicle. Alternatively, the flap can be rotated in a plane parallel to the charging recess. Alternatively, the flap can be moved upwards or downwards or to the side via a corresponding guide in order to be transferred to one of the releasing positions. In this case, the respective flap can be moved outwards in front of a body shell or inwards under the body shell in order to be transferred to one of the releasing positions. A combination of swiveling and turning or swiveling and sliding or turning and sliding is also conceivable. In addition, the charging connection covers can be moved in different ways. For example, a first charging connection cover can be swiveled and a second charging connection cover can be slid. Alternatively, the opening mechanism of both charging connection covers can be identical or mirrored to each other. Furthermore, the cover element can be moved differently than at least one of the charging connection covers. Alternatively, the cover element can be identical or mirrored to the opening mechanism of at least one charging connection cover.

According to an advantageous embodiment of the charging connection device, at least one of the charging connection covers and/or the at least one cover element can be designed as a foldable or rollable or bendable roller blind. The roller blind can be made of plastic or sheet metal. In this case, the roller blind can be designed in one piece or the roller blind can have several slats. In the foldable or slatted design, the roller blind can be folded and unfolded to be moved into one of the releasing positions or into the covering position. In the roll-up version, the roller blind can be rolled up and unrolled in order to be moved to one of the releasing positions or to the covering position. In the bendable version, the roller blind can be folded inwards or outwards or to the side from the covering position in order to be moved to one of the releasing positions. Furthermore, an arrangement that moves inwards, similar to a center console cover, or an S-shaped arrangement that folds inwards is also conceivable. Other possible designs include louvre and roller blind systems and bendable designs that can roll away at least by an angle. In this case, a flexible sheet, for example a spring sheet, which does not have individual slats, can also be bent away and/or pushed away around a corner or by an angle. The movements between the positions of the roller blind can be carried out upwards, downwards, to the left or to the right.

With the charging connection device according to the invention, it can be advantageously ensured that only one charging connection or certain contact elements are accessible for contacting and the other charging connection or the other contact elements are covered so that they cannot be touched.

Further advantages can be found in the following description of the drawings. The drawings show an exemplary embodiments of the invention. The drawings, the description and the claims contain numerous features in combination. A person skilled in the art will also expediently consider the features individually and summaries them to form useful further combinations.

### BRIEF DESCRIPTION OF THE DRAWING FIGURES

In the drawings:

FIG. 1 shows a charging connection device for an electrically powered vehicle with two charging connections according to a first exemplary embodiment of the invention with fully covered charging connections;

FIG. 2 shows the charging connection device according to FIG. 1 with released AC contact elements of the combined DC-AC charging connection;

FIG. 3 shows the charging connection device according to FIGS. 1 and 2 with released AC contact elements and DC contact elements of the combined DC-AC charging connection;

FIG. 4 shows a charging connection device for an electrically powered vehicle with two charging connections according to a second exemplary embodiment of the invention with fully covered charging connections;

FIG. 5 shows the charging connection device according to FIG. 4 with released AC contact elements of the combined DC-AC charging connection; and

FIG. 6 shows the charging connection device shown in FIGS. 4 and 5 with released AC contact elements and DC contact elements of the combined DC-AC charging connection.

In the figures, like or similar components are denoted by like reference signs. The figures only show examples and are not intended to be limiting.

### DETAILED DESCRIPTION

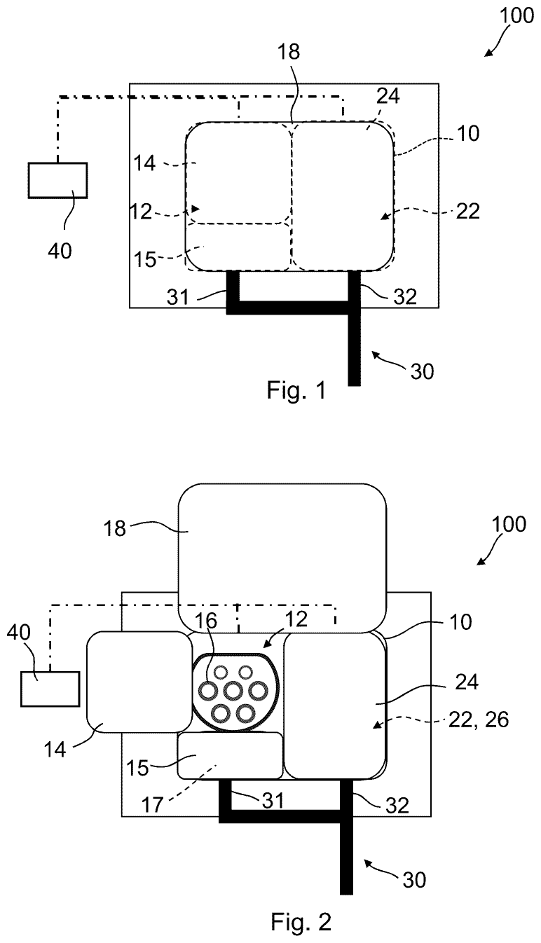

FIGS. 1 to 3 show a charging connection device 100 for an electrically powered vehicle with two charging connections 12, 22 according to a first exemplary embodiment of the invention.

FIGS. 4 to 6 show a charging connection device 100 for an electrically powered vehicle with two charging connections 12, 22 according to a second exemplary embodiment of the invention.

In the following, the common features of the illustrated exemplary embodiments of the charging connection devices 100 will be discussed first and the differences between the illustrated charging connection devices 100 will be discussed in the further course.

As can be seen from FIGS. 1 to 6, the illustrated exemplary embodiments of the charging connection devices 100 for an electrically powered vehicle each comprise two adjacently arranged charging connections 12, 22.

As can be further seen from FIGS. 2, 3, 5 and 6, the charging connections 12, 22 correspond to charging sockets, but other suitable charging connections 12, 22 are also conceivable. As can also be seen from FIGS. 2, 3, 5 and 6, a charging connection 12 arranged on the left is designed as a combined DC-AC charging connection 12 in the corresponding exemplary embodiment of the charging connection device 100. The charging connection 22 arranged on the right can be designed as a DC charging connection 22 or as an AC charging connection 22 or as a further combined DC-AC charging connection 22.

The designations left and right are of course exemplary. The combined DC-AC charging connection 12 shown can of course also be arranged on the right. Furthermore, the charging connections 12, 22 can also be arranged offset to one another or below one another in an exemplary embodiment not shown.

As can also be seen from FIGS. 1 to 6, the charging connections 12, 22 are electrically coupled via a common electrical path 30. The two charging terminals 12, 22 arranged adjacently in the common electrical path 30 are connected in parallel. Each charging terminal 12, 22 has an electrical coupling 31, 32. No separating elements are required to separate the charging connections 12, 22. Both charging connections 12, 22 are energized.

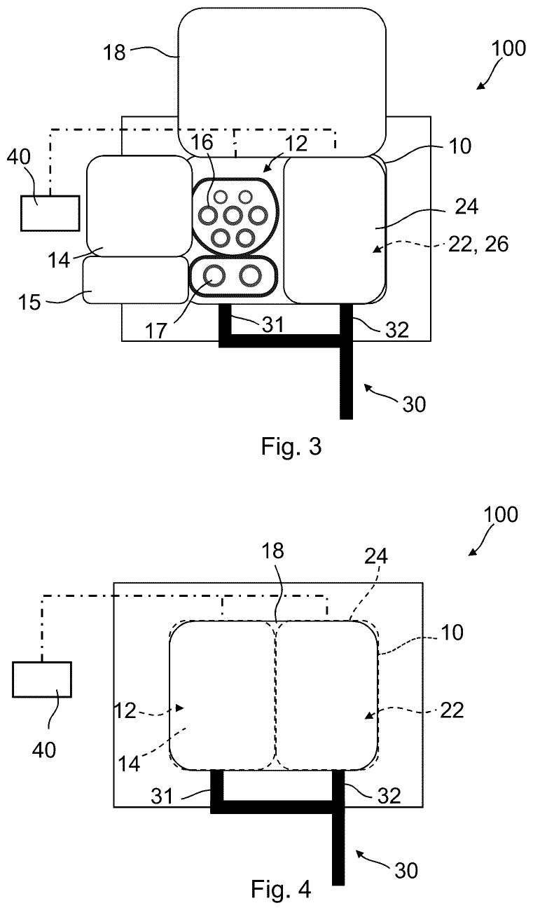

As can also be seen from FIGS. 3 and 6, the combined DC-AC charging connection 12 has two types of contact elements 16, 17. Alternating current contact elements 16 are arranged above DC contact elements 17.

As can be further seen from FIGS. 1 to 6, at least two movably mounted charging connection covers 14, 15, 24 are each assigned to one of the charging connections 12, 22, wherein the charging connection covers 14, 15, 24 each cover the corresponding charging connection 12, 22 in at least one covering position and at least partially release contact elements 16, 17, 26 of the corresponding charging connection 12, 22 in at least one releasing position.

As can also be seen from FIGS. 1 to 6, an inhibiting arrangement 40 inhibits at least one of the charging connection covers 14, 15, 24 for a transition from the at least one covering position to at least one releasing position or for a transition between releasing positions if the release of the charging connection 12, 22 assigned to the charging connection cover 14, 15, 16 or its contact elements 16, 17, 26 is not required for the current charging mode and/or if at least one of the charging connection covers 14, 15, 24 has one of the releasing positions. As a result, only one charging connection 12, 22 assigned to the charging mode or contact elements 16, 17, 26 of the charging connection 12, 24 assigned to the charging mode are accessible for contacting during a charging process, while the other of the two charging connections 12, 22 or the other contact elements 16, 17, 26 are covered by the respective charging connection cover 14, 15, 24, in particular covered in a touch-proof manner. As a result, it is only possible to insert a plug into the corresponding charging connection 12, 22 or to couple it with the corresponding contact elements 16, 17, 26 if the other charging connection 12, 22 or the other contact elements 16, 17, 26, which are not assigned to the charging mode assigned to the plug, are covered with the respective charging connection cover 14, 15, 24 so that they are safe to touch. This ensures that, during charging, the unused, energized charging connection 22 or unused contact elements 16, 17, 26 are covered so that they are safe to touch. In addition, the unused, energized charging connection 22 or the unused contact elements 16, 17, 26 are protected from environmental influences such as dirt or water.

As can also be seen from FIGS. 1 to 6, the charging connection device 100 fundamentally has four or more states.

In a first state (FIGS. 1 and 4), both charging connections 12, 22 are covered by the respective charging connection cover 14, 15, 24 or by the respective charging connection covers 14, 15, 24. In the illustrated exemplary embodiments, an additional common cover element 18 covers all charging connections 12, 22 and the respective charging connection covers 14, 15, 24.

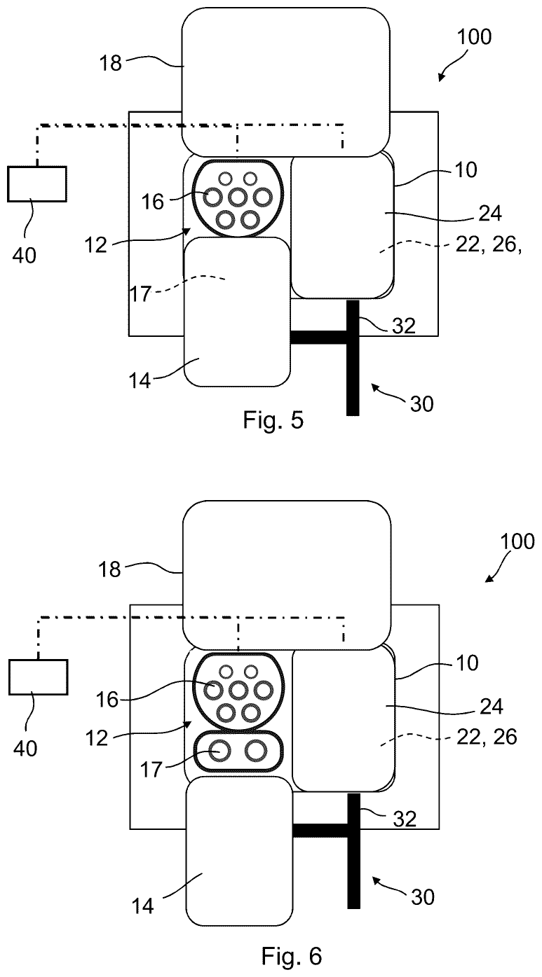

In a second state of the charging connection device 100 (FIGS. 2 and 5), the DC contact elements 17 of the combined DC-AC charging connection 12 and the other charging connection 22 are covered by the respective charging connection cover 14, 15, 24. As a result, in the second state, only the AC contact elements 16 of the combined DC-AC charging connection 12 are released for a CCS AC charging mode.

In a third state of the charging connection device 100 (FIGS. 3 and 6), the other charging connection 22 is covered by the respective charging connection cover 24 and the AC contact elements 16 and the DC contact elements 17 of the combined DC-AC charging connection 12 are released for a CCS DC charging mode.

In a fourth state, not shown, the combined DC-AC charging connection 12 is covered by the respective at least one charging connection cover 14, 15 and the other charging connection 22 is at least partially released for a corresponding charging mode by the respective at least one charging connection cover 24. If the other charging connection 22 also has different types of contact elements 26 for different charging modes, further states are conceivable.

In one exemplary embodiment of the charging connection device 100, the inhibiting arrangement 40, which is not shown in greater detail, can comprise at least one locking element that locks a corresponding charging connection cover 14 15, 24 in a covering position or in a first releasing position, in which AC contact elements 16 are released and DC contact elements 17 are covered. Alternatively, or additionally, the inhibiting arrangement 40 may comprise at least one blocking arrangement that blocks an actuator driving at least one of the charging connection covers 14 15, 24. The drive can be an actuator or a suitable actuator. The locking element can be a locking pin, which can be moved between a locking position and an unlocking position. The locking pin can be used to mechanically lock the respective charging connection cover 14, 15, 24. The blocking arrangement can be used to mechanically block the drive or a mechanical force transmission path between the drive and the respective charging connection cover 14, 15, 24. Furthermore, it is possible to decouple the mechanical power transmission path between the respective charging connection cover 14, 15, 24 and the corresponding drive, or to interrupt the power supply to the corresponding electric drive.

A possible realization can be controlled via sensors and actuators. Additionally, or alternatively, a passive implementation using simple mechanical functions is also possible.

For example, the charging connection covers 14, 15, 24 can be mechanically coupled to one another in such a way that a change in position of one of the charging connection covers 14, 15, 24 causes the at least one other charging connection cover 14, 15, 24 to lock or block.

At least one sensor arrangement, not shown, coupled to the inhibiting arrangement 40 monitors the current position of the charging connection covers 14, 15, 24. Alternatively or additionally, the at least one sensor arrangement can recognize the current charging mode. Depending on the charging mode recognized by the sensor arrangement, the at least one drive moves the charging connection covers 14, 15, 24 into the position in which only the charging connection 12, 22 assigned to the charging mode or the contact elements 16, 17, 26 of the charging connection 12, 24 assigned to the charging mode are released. The sensor arrangement can comprise a limit switch and/or an optical sensor and/or a camera and/or a position measuring system or potentiometer. Through the sensor arrangement, a suitable evaluation unit recognizes which cover 14, 15, 18, 24 is open and controls the locking element or the blocking arrangement accordingly. This can be done mechanically via suitable actuators or electrically via suitable elements.

As can also be seen from FIGS. 1 to 6, the two charging connections 12, 22 are arranged in a common charging recess 10 in the illustrated exemplary embodiments of the charging connection device 100 and are electrically interconnected, wherein the same voltage is applied to both charging connections 12, 22.

An additional cover element 18 is provided, which covers the charging recess 10 in a first state of the charging connection device 100. In one of the other states of the charging connection device 100, the cover element 18 at least partially releases the charging recess 10. The illustrated cover element 18 is mounted so as to be displaceable in the upward direction and is moved upwards to release the charging recess 10 and downwards to cover the charging recess 10. In an alternative exemplary embodiment, not shown, the cover element 18 can also be displaced in another suitable direction. In addition, the cover element 18 can be pivotably mounted about a suitable axis, similar to known fuel filler lids. Furthermore, in an alternative embodiment, the cover element 18 can be designed as a foldable or rollable or bendable roller blind. Furthermore, it is possible to dispense with covering the charging recess 10 with an additional cover element 18.

In an alternative embodiment, not shown, the charging connections 12, 22 can also be arranged in separate charging recesses 10 in particular disposed adjacently, which are arranged separately from one another and are electrically interconnected internally, wherein the same voltage is applied to both charging connections 12, 22.

As can also be seen from FIGS. 1 to 6, in the illustrated exemplary embodiments of the charging connection device 100, the charging connection covers 14, 15, 24 are designed as translationally movably mounted flaps. In the illustrated exemplary embodiments, the charging connection covers 14, 15, 24 are moved in front of the outer skin of the body shell; it would also be possible to slide them behind the outer skin of the body shell.

In an alternative exemplary embodiment of the charging connection device 100, which is not shown, at least one of the charging connection covers 14, 15, 24 can be designed as a rotationally movably mounted flap. In this case, the flap can be swiveled or folded forwards on a suitable axis. Furthermore, a combination of a translational and a rotational movement of the flap is conceivable.

Furthermore, one flap can be slidable and one flap can be swiveled or rotated.

In a further exemplary embodiment of the charging connection device 100, which is not shown, at least one of the charging connection covers 14, 15, 24 can be designed as a foldable or rollable or bendable roller blind. In this case, the roller blind can be made of plastic or sheet metal, which can be rolled up and folded or moved away inwards. The roller blind can also fold inwards in an S-shape. The movement can be carried out upwards, downwards, to the left, or to the right. The roller blind can be designed as an arrangement of slats or as a bendable spring sheet. Slats and roller blind systems that can be rolled up or at least rolled away at an angle are another conceivable option. It is also conceivable to design the roller blind as a flexible sheet that does not have individual slats, but can be bent away or pushed away around a corner or by an angle.

As can be further seen from FIGS. 1 to 3, the first exemplary embodiment of the charging connection device 100 comprises at least three movably mounted charging connection covers 14, 15, 24. A first charging connection cover 14 is assigned to the AC contact elements 16 of the combined DC-AC charging connection 12, a second charging connection cover 15 is assigned to the DC contact elements 17 of the combined DC-AC charging connection 12 and a third charging connection cover 24 is assigned to the further charging connection 22. The first charging connection cover 14 and the second charging connection cover 15 are moved to the left in the illustrated exemplary embodiment in order to release the contact elements 16, 17 assigned to them. The first charging connection cover 14 and the second charging connection cover 15 are moved to the right in order to cover the contact elements 16, 17 assigned to them. The first charging connection cover 14 and the second charging connection cover 15 have the covering position in the first and in the fourth state of the charging connection device 100. The second charging connection cover 15 also has the covering position in the second state of the charging connection device 100.

Alternatively, the first charging connection cover 14 can also be moved upwards and the second charging connection cover 15 downwards to release the contact elements 16, 17. A swiveling movement or a rotating movement is also conceivable. It should be noted that the second charging connection cover 14 does not cover the AC contact elements 16, 17 in the releasing position (FIG. 3).

The third charging connection cover 24 can also be moved to the side or upwards or downwards to release the further charging connection 22 assigned to it or can be moved in the opposite direction to cover the further charging connection 22 assigned to it. A swiveling movement or a rotating movement is also conceivable. The third charging connection cover 24 has the covering position in the first, second and third state of the charging connection device 100.

As can be further seen from FIGS. 4 to 6, the second exemplary embodiment of the charging connection device 100 comprises two movably mounted charging connection covers 14, 24. A first charging connection cover 14 is assigned to the combined DC-AC charging connection 12 and a second charging connection cover 24 is assigned to the further charging connection 22. At least the first charging connection cover 14 is movable between the covering position (FIG. 4) and two releasing positions (FIGS. 5 and 6). In the covering position (FIG. 4), the first charging connection cover 14 covers the AC contact elements 16 and the DC contact elements 17. The first charging connection cover 14 has this position in the first state and in the fourth state of the charging connection device 100. In a first releasing position (FIG. 5), the first charging connection cover 14 releases the AC contact elements (16) and covers the DC contact elements 17. The first charging connection cover 14 has the first releasing position in the second state of the charging connection device 100. In a second releasing position (FIG. 6), the first charging connection cover 14 releases the AC contact elements 16 and the DC contact elements 17. The first charging connection cover 14 has the second releasing position in the third state of the charging connection device 100. Here, during a transition from the covering position to the second releasing position, the first charging connection cover 14 can be moved to the second releasing position without stopping in the first releasing position.

The second charging connection cover 24 can also be moved to the side or upwards or downwards to release the further charging connection 22 assigned to it or can be moved in the opposite direction to cover the further charging connection 22 assigned to it. A swiveling movement or a rotating movement is also conceivable. The second charging connection cover 24 has the covering position in the first, second and third state of the charging connection device 100. In the releasing position, the second charging connection cover 22 releases the further charging connection 22 in the exemplary embodiment shown. The second charging connection cover 22 has the releasing position in the fourth state of the charging connection device 100.

In an exemplary embodiment of the charging connection device 100 that is not shown, the cover variants of the first exemplary embodiment and the second exemplary embodiment can be combined with one another.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

10 charging recess
12 charging connection
14 charging connection cover
15 second charging connection cover
16 AC contact elements
17 DC contact elements
18 cover element
22 charging connection
24 charging connection cover
26 contact elements
30 electrical path
31 electrical coupling
32 electrical coupling
40 inhibiting arrangement
100 charging connection device

1-10. (canceled)

11. A charging connection device for an electrically propelled vehicle, the charging device comprising:
two adjacently arranged charging connections, which are charging sockets, wherein a first of the two charging connections is a combined DC-AC charging connection with two types of contact elements and a second of the two charging connections is a DC charging connection, an AC charging connection, or a further DC-AC charging connection, wherein the two adjacently arranged charging connections are electrically coupled via a common electrical path;
at least two movably mounted charging connection covers, wherein each of the two charging connections is assigned at least one of the at least two movably mounted charging connection covers, wherein the at least two movably mounted charging connection covers each cover a corresponding one of the two charging connections in at least one covering position and at least partially release contact elements of the corresponding charging connection in at least one releasing position;
an inhibiting arrangement configured to inhibit at least one of the at least two movably mounted charging connection covers for a transition from the at least one covering position to at least one releasing position or for a transition between releasing positions if a release of the corresponding charging connection assigned to the corresponding one of the at least two movably mounted charging connection covers or contact elements the corresponding one of the at least two movably mounted charging connection covers is not required for a current charging mode or if at least one of the at least two movably mounted charging connection covers has one of the releasing positions, so that, during a charging process, only one of the two charging connections, which is assigned to the charging mode, or contact elements one of the two charging connections are accessible for contacting, while another one of the two charging connections or contact elements of the other one of the two charging connections are covered by the respective one of the at least two movably mounted charging connection covers, so as to be safe to touch; and
at least one sensor arrangement coupled to the inhibiting arrangement and configured to monitor a current position of the at least two movably mounted charging connection covers or is configured to recognize the current charging mode.

12. The charging connection device of claim 11, further comprising:
at least one drive configured to, depending on the charging mode recognized by the sensor arrangement, move the at least two movably mounted charging connection covers into a position in which only the charging connection assigned to the charging mode or the contact elements of the charging connection assigned to the charging mode are released.

13. The charging connection device of claim 11, wherein the at least two movably mounted charging connection covers comprises at least three movably mounted charging connection covers, which include a first, second, and third charging connection cover, wherein the first charging connection cover is assigned to AC contact elements of the combined DC-AC charging connection, the second charging connection cover is assigned to DC contact elements of the combined DC-AC charging connection, and at least the third charging connection cover is assigned to the further charging connection.

14. The charging connection device of claim 11, wherein the at least two movably mounted charging connection covers includes first and second charging connection covers, wherein the first charging connection cover is assigned to the combined DC-AC charging connection and the second charging connection cover is assigned to the further charging connection, wherein at least the first charging connection cover is movable between the covering position and two releasing positions, wherein the first charging connection cover covers the AC contact elements and the DC contact elements in the covering position, releases the AC contact elements and covers the DC contact elements in a first releasing position and releases the AC contact elements and the DC contact elements in a second releasing position.

15. The charging connection device of claim 11, wherein the two charging connections are arranged in a common charging recess.

16. The charging connection device of claim 11, wherein the two charging connections are arranged in two separate and adjacently arranged charging recesses.

17. The charging connection device of claim 16, wherein at least one of the two separate and adjacently arranged charging recesses comprises at least one cover element covering a corresponding charging recess in at least a first position and at least partially releases the corresponding charging recess in at least a second position, wherein the at least one cover element is arranged above the at least two movably mounted charging connection covers with respect to a vehicle environment.

18. The charging connection device of claim 11, wherein the inhibiting arrangement comprises at least one locking element configured to lock a corresponding charging connection cover in at least one covering position or in at least one releasing position.

19. The charging connection device of claim 11, wherein the inhibiting arrangement comprises at least one blocking arrangement configured to block at least one drive configured to drive the at least two movably mounted charging connection covers.

20. The charging connection device of claim 17, wherein at least one of the at least two movably mounted charging connection covers or the at least one cover element is a rotationally movably mounted flap or a translationally movably mounted flap.

21. The charging connection device of claim 17, wherein at least one of the at least two movably mounted charging connection covers or the at least one cover element is a foldable, rollable, or bendable roller blind.
